(19) United States
(12) Patent Application Publication
(10) Pub. No.: US 2026/0057101 A1
(43) Pub. Date: Feb. 26, 2026

(54) Data Leak Prevention for Multimedia Data

(71) Applicant: Lookout Inc., Boston, MA (US)

(72) Inventors: Meenakshi Sundaram Lakshmanan, San Jose, CA (US); Nitesh Kumar, Hyderabad (IN); Bastien Bobe, Mogneneins (FR)

(21) Appl. No.: 18/812,656

(22) Filed: Aug. 22, 2024

(51) Int. Cl. G06F 21/62; G06V 10/764; G06V 30/10; G10L 15/26

(52) U.S. Cl. CPC G06F 21/6245; G06V 10/764; G06V 30/10; G10L 15/26

(57) ABSTRACT

Data loss prevention may be performed with respect to multimedia data at the time of distribution, whether as part of an email, live video conference, or retrieval from a software as a service (SaaS) application. Multimedia data is intercepted and divided into channels (text, audio, video). Audio and video channels are converted into text. Images of video may be processed using optical character recognition or object recognition. Text obtained from the multimedia data is processed to determine whether the text includes sensitive data that an intended recipient of the multimedia data is not authorized to access. If so, a remediating action may be performed, such as blocking or redacting the multimedia data.

### BACKGROUND

In a modern enterprise, there is a wide array of devices in use by members of the enterprise, all of which may access or generate sensitive data. It is in the interest of the enterprise to protect the security of its data on each device on which it may be found.

### BRIEF DESCRIPTION OF THE FIGURES

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a network environment for processing emails in accordance with an embodiment of the present invention;

FIG. 2 is a process flow diagram of another network environment for processing network traffic in accordance with an embodiment of the present invention;

FIG. 3 illustrates the interception and processing data managed by software as a service (SaaS) applications in accordance with an embodiment of the present invention;

FIG. 4 illustrates a method for preventing data leakage in accordance with an embodiment of the present invention;

FIG. 5 illustrates the generation of text from multimedia data in accordance with an embodiment of the present invention;

FIG. 6 illustrates inputs used to detect leakage of sensitive data in accordance with an embodiment of the present invention;

FIG. 7 is a process flow diagram of a method for performing remediation in accordance with an embodiment of the present invention; and

FIG. 8 is a schematic block diagram of a computer system suitable for implementing methods in accordance with embodiments of the present invention.

### DETAILED DESCRIPTION

It will be readily understood that the components of the invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Embodiments in accordance with the invention may be embodied as an apparatus, method, or computer program product. Accordingly, the invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the invention may be written in any combination of one or more programming languages, including an object-oriented programming language such as Java, Objective-C, Swift, C++, or the like and conventional procedural programming languages, such as the “C” programming language or similar programming languages, and may also use descriptive or markup languages such as HTML, XML, JSON, and the like. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Data is the new Gold. This statement specifically holds true for enterprise organizations, and they want to make sure that sensitive data is not lost, misused, abused or accessed by unauthorized users. At the same time organizations are required to comply with various data related regulations such as Health Insurance Portability and Accountability Act (HIPAA), General Data Protection Regulation (GDPR), California Consumer Privacy Act (CCPA) etc.

To address this, organizations deploy data loss prevention (DLP) Tools and processes. Such tools may be offered by security vendors. These tools and processes identify data loss and take corrective actions through alerts, encryption to prevent intentional or unintentional data loss. DLP tools and processes also regulate endpoint actions, filter data transmissions across corporate networks that may happen in public, private or hybrid clouds. Furthermore, DLP tools help auditing actions, pinpoint vulnerabilities and irregularities for forensic analysis and incident response.

In the era of hyper availability of information, data can be lost in various forms such as through text, audio video and through means such as multimedia. Certain examples of types of data that can be lost through multimedia include:
Text: written content, including titles, subtitles, captions, and any other textual information, is a fundamental component of multimedia. Text can provide context, explanations, or instructions within multimedia presentations.
Graphics: graphics encompass various visual elements such as screenshots, images, illustrations, diagrams, charts, graphs, icons, and logos.
Audio: audio components in multimedia can include music, sound effects, narration, spoken dialogue, and ambient sounds.
Video: video elements consist of moving images, animations, and recorded footage. They can range from short clips to full-length movies or presentations. Video content engages viewers visually and can effectively demonstrate processes, tell stories, or illustrate concepts.

There are various means through which types of data mentioned above can be lost. Some of the examples include-video conferencing, audio conferencing, audio calls, emails, storage drives, applications, media file sharing (through offline means), podcasts, websites, online or in-person presentations, webinars etc.

While there are DLP solutions that attempt to address text data loss through emails, storage drives and websites, there are not many solutions available that address data loss through audio, video and graphics format. Moreso, in the context of multimedia, frequently, various types of data are combined together (such as text, audio and video) and there is no solution that addresses the data loss through each of those means.

In one common scenario, video conferencing, confidential documents can be shared as screen share. The meeting can involve diverse groups of individuals, who may or may not belong to the same organization. At the same time, whoever is sharing the document on the screen may not know they are sharing confidential information, which can leak to the external world. An organizer of the meeting or a meeting attendee may invite an external party to a video meeting and that external party can capture the screen using a different video recording tool. Additionally, most video conferencing tools also provide the downloadable video file offline, and if a document is uploaded within conferencing, that also leads to data leakage issues.

Hence, there is a need in the world of webRTC (web real time conferencing) to perform a DLP scan of real time video data and apply the appropriate policy on the shared documents that are shared through a screen sharing option. Additionally, there is a need for a DLP solution that can scan documents uploaded in the video conferencing.

Additionally, in the case of podcasts and presentations, data can be lost if the speaker advertently or inadvertently shares sensitive information. There is a need in the industry for DLP solutions that can scan audio information from the podcasts and similar multimedia.

There is also a need in the industry for providing DLP solutions for file sharing (stored, sent or received) on a variety of systems that includes on-premise and cloud based systems. Protecting content from data loss is more challenging than it might seem on such systems. Modern enterprises store their data across various on-premises and cloud-based systems, including software as a service (SaaS) platforms, such as Office 365, SharePoint, Windows File Shares, Box, and others. While it's impractical to consolidate content onto a single platform, expecting a DLP solution to seamlessly integrate with all these diverse systems is equally challenging. There is a need in the industry that provides a DLP solution across a variety of static file access solutions.

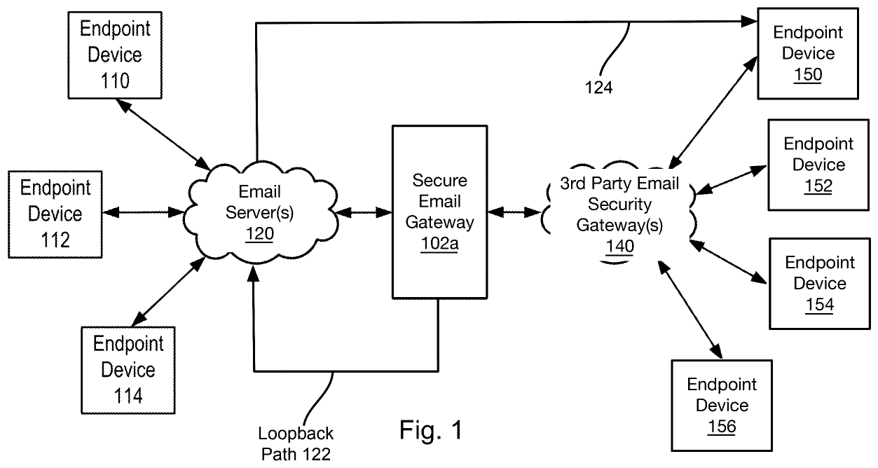

FIG. 1 shows endpoint devices 110, 112, 114 that may be the source of emails that are processed by a secure email gateway 102a. For example, the endpoint devices 110, 112, 114 may be mobile phones, notebook computers, desktop computers, or other type of device. The endpoint devices 110, 112, 114 may execute mobile phone email clients, desktop email clients (e.g., OUTLOOK, mail client of MACOS), browser-executed email clients, or other types of email clients.

Emails may be transmitted by the endpoint devices to one or more email servers 120. The email servers may be on-premise servers of an enterprise or third-party servers, such as an EXCHANGE server, GMAIL server, or other third-party email server. The emails may be transmitted according to any email protocol known in the art, such as ACTIVESYNC, EXCHANGE web service (EWS), messaging application programming interface (MAPI), hypertext transfer protocol secure (HTTPS), internet message access protocol (IMAP), post office protocol 3 (POP3), or the like.

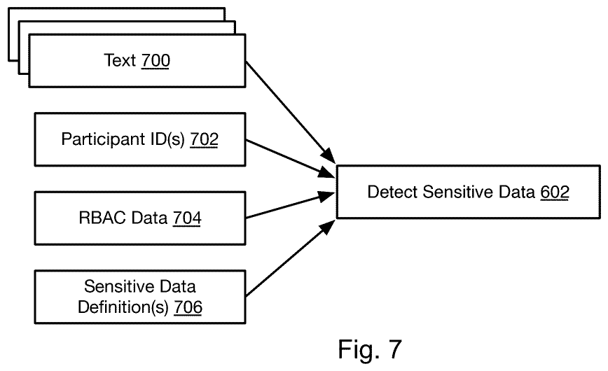

The email servers 120 may be configured with rules that transmit emails to the secure email gateway 102a prior to sending the emails to recipients addressed by the emails. For example, the email servers 120 may transfer the emails to the secure email gateway 102a according to the simple mail transfer protocol secure (SMTPS). The secure email gateway 102a evaluates the emails with respect to a policy and performs any remediation required according to the policy (see FIG. 7 and corresponding discussion). The emails, which may be modified according to the remediation) may be forwarded to the recipients addressed by the emails using multiple approaches. In a first approach, the secure email gateway 102a forwards an email (which may be modified) to the email server 120 from which the email was received using a loopback path 122. The email server 120 from which the email was received may then forward the email to the recipient along a path 124 to an endpoint device 150, 152, 154, 156 executing an email client that is authenticated with respect to a recipient address of the email. The endpoint devices 150, 152, 154, 156 executing any of the email clients described above. The path 124 may be any network path through any number of intermediate servers or other network elements.

Alternatively, following processing by the secure email gateway 102a, the email (which may be modified) may be forwarded to one or more third party email security gateways, which then forward the email to an endpoint device 150, 152, 154, 156 executing an email client that is authenticated with respect to a recipient address of the email. The email gateway 140 may implement a mail transfer agent (MTA) and may implement zero or more additional firewalls, controls, filters, or other processes with respect to the email.

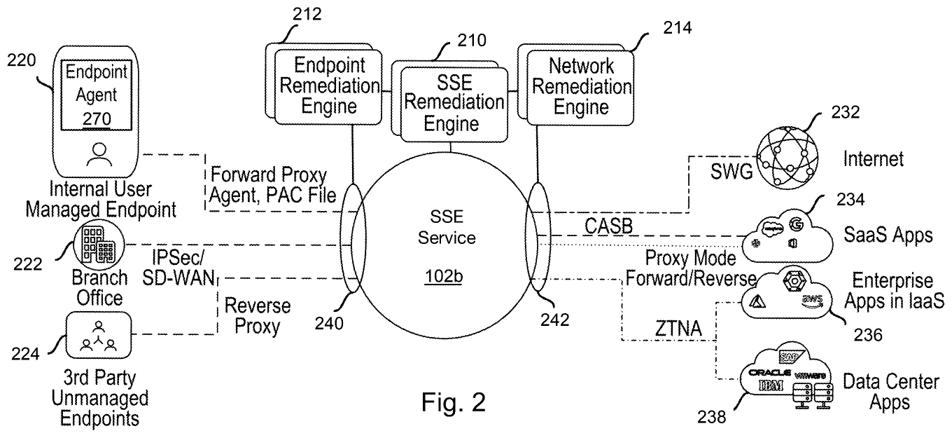

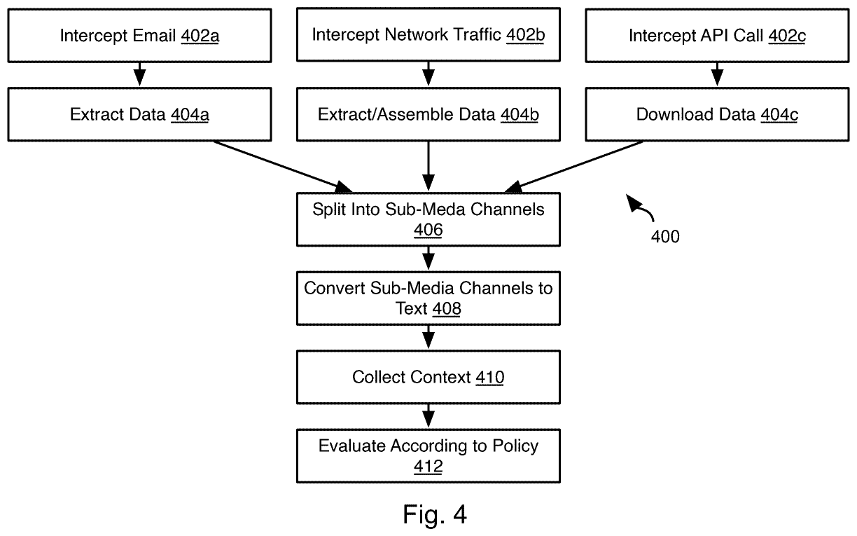

FIG. 2 shows secure server edge (SSE) service 102b implementing an SSE remediation engine 210, in accordance with some embodiments. In one embodiment, SSE remediation engine 210 includes an endpoint remediation engine 212 and/or a network remediation engine 214. The SSE remediation engine 210 with one or both of the endpoint remediation engine 212 and network remediation engine 214 may implement the methods described below with respect to FIGS. 4 through 7.

Various endpoint devices communicate through the SSE service 102b with various remote computing devices. Endpoint devices include, for example, managed endpoints 220, user devices in branch office 222, and unmanaged endpoints 224. Remote computing devices include, for example, Internet servers 232, software as a service (SaaS) cloud 234, infrastructure as a service (IaaS) cloud 236, and data center servers 238.

In some embodiments, each endpoint device has an endpoint agent. For example, endpoint agent 270 is shown installed on endpoint 220. Each endpoint agent may be capable of blocking connections 240 on its respective endpoint device. Each endpoint agent may be able to enforce security at the process level, such as blocking an entire process.

In some embodiments, network remediation engine 214 takes security actions that affect communications on connections 242 with remote computing devices. For example, network remediation engine 214 sends signals (e.g., using a server API) to network agents to block communication on a connection 242. In one example, the network agents reside on servers that provide SaaS applications. For example, the signals to the network agent terminate action with respect to a file or other stored data.

The SSE service 102b generally inspects and evaluates traffic through the SSE service 102b according to a policy and may invoke remediative actions based on the policy (see FIG. 7 and corresponding disclosure). Remediative actions may be performed by the SSE service 102b itself, through the endpoint agents 270, and/or through an API of a remote server (e.g., an API of SaaS application executing in the SaaS cloud 234). Instead of, or in addition to, communicating with the endpoint agent 270, the SSE service 102b in some cases can use an API of the SaaS app to have the SaaS app take some remediative action (e.g., shut down access to specified data).

In some embodiments, managed endpoints 220 communicate with remote servers (and/or other remote computing devices) using a proxy auto-config (PAC) file. In one example, the PAC file defines how web browsers and other user agents on endpoints 220 automatically choose a proxy server (e.g., the SSE service 102b) for fetching a URL. In one example, the PAC file includes a JavaScript function for implementing the approach described herein.

In some embodiments, managed endpoints 220 communicate with remote computing devices using a forward proxy implemented by the SSE service 102b. In one example, the forward proxy is a server application that acts as an intermediary between a client requesting a resource and the server providing that resource. When the endpoint makes a request for a resource, such as a file or web page, the endpoint directs the request to the proxy server. The proxy server evaluates the request and performs required network transactions.

In some embodiments, the forward proxy resides on the endpoint device itself. In one example, the forward proxy is an Internet-facing proxy used to retrieve data from remote computing devices on the Internet.

In some embodiments, communications to unmanaged endpoints 224 (e.g., from remote computing devices) pass through a reverse proxy. The reverse proxy is used to control and protect access to the endpoints 224 (and/or other computing devices on a private network behind SSE service 102b). In one example, the reverse proxy performs load-balancing, authentication, decryption and/or caching.

In some embodiments, one or more of the user devices in branch office 222 communicate with one or more remote computing devices using a security protocol. For example, the security protocol can be Internet Protocol Security (IPsec). IPsec is a secure network protocol that authenticates and encrypts packets of data to provide secure encrypted communication between two computers over an Internet Protocol network. For example, IPsec is used in virtual private networks (VPNs).

In some embodiments, IPsec includes protocols for establishing authentication between communicating devices (e.g., by software agents on the devices) at the beginning of a session, and sharing of cryptographic keys to use during the session. In one example, IPsec protects data flows between endpoint devices and SSE service 102b. In one example, IPsec implements network-level peer authentication, data origin authentication, data integrity, data confidentiality (encryption), and/or replay protection.

In some embodiments, various endpoint devices can communicate with SSE service 102b over one or more networks using software-defined wide area networks (SD-WAN). In one example, the SD-WAN supports applications and SaaS services such as SLACK, SALESFORCE, WORKDAY, BOX, DROPBOX, MICROSOFT 365, or the like.

In some embodiments, the SD-WAN uses software-defined network technology and communicates over a network using overlay tunnels (e.g., for communications between internal enterprise nodes). For example, SD-WAN can decouple networking hardware from networking control. In one embodiment, communication with remote computing devices (e.g., Internet servers 232) uses a secure web gateway (SWG). The SWG blocks certain types of communications with servers 232 (e.g., communications by endpoints 220). The SWG can include one or more firewalls and be, for example, implemented by SSE service 102b. In one example, the SWG protects endpoint devices from accessing and being infected by malicious web traffic, websites with vulnerabilities, internet-borne viruses, malware, and/or other cyber threats. In one example, the SWG additionally and/or alternatively enforces compliance with one or more policies applicable to the endpoint devices (e.g., to prevent confidential information from being exposed externally).

In one embodiment, communications by remote computing devices (e.g., servers associated with IaaS cloud 236, and/or data center server 238) with endpoint and/or other computing devices on a private network is implemented using Zero Trust Network Access (ZTNA) mechanism. In one example, the ZTNA enforces policies for providing access to endpoint devices. In one example, the policy is enforced based on context. The context can be a combination of user identity, user or service location, time of the day, type of service, and/or security posture of the endpoint device. In one example, the ZTNA is part of the SSE service 102b. In one example, the ZTNA is configured in real-time by the SSE service 102b based on metadata gathered from endpoint and/or network devices.

The SSE service 102b is able to enforce security controls granularly based on, for example, source IP address and destination IP address. Enforcement can also be done at a port level.

In one embodiment, endpoint remediation engine 212 can take security control and/or remediation actions at any device on a private network behind the SSE service 102b that is implementing or using a forward or reverse proxy. Endpoint remediation engine 212 can configure IPsec and/or SD-WAN usage for any endpoint or network device (e.g., configure consistent with a policy to be applied when certain security risks are identified).

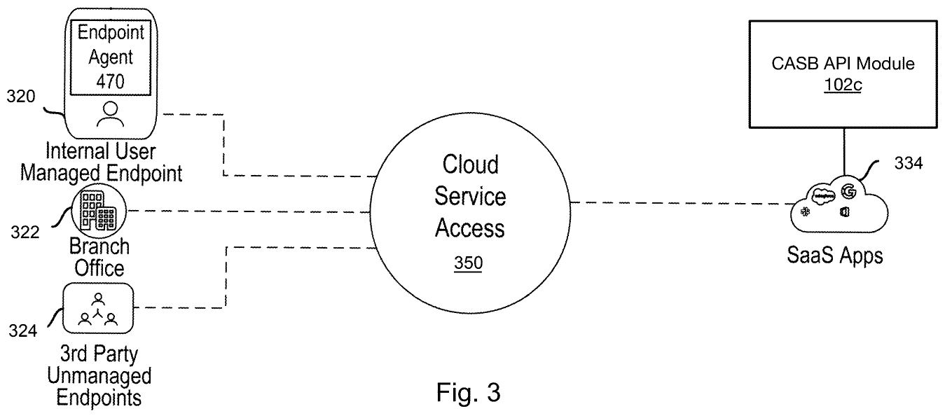

FIG. 3 shows a cloud access security broker (CASB) application programming interface (API) module 102c that interfaces with APIs of one or more software as a service (SaaS) applications 334 in order to perform DLP.

Endpoints 320, 322, 324 may communicate with SaaS applications 334 using cloud service access 350. In one example, cloud service access 350 is a network gateway and/or other network communication path. In one embodiment, a computing device providing cloud service access 350 includes a proxy and/or firewall.

The CASB API module 102c interfaces with the SaaS applications 334 to monitor API calls made to these SaaS applications 334. In particular, API calls performing storage, retrieval, or sharing of data may be intercepted and evaluated using the CASB API module 102c. For example, API calls that are intercepted and evaluated may include those that invoke downloading data, creating of links for invoking downloading of data (e.g., public links that do not require authentication to access), writing data to a publicly accessible folder, writing of data to a repository, or retrieving of data from a repository. The CASB API module 102c may operate “out of band” in the sense that some operations of the CASB API module 102c with respect to a SaaS application 334 are performed independent of interactions between endpoints 320, 322, 324 and the SaaS application 334. For example, CASB API module 102c may periodically (or in response to a detected change) scan databases, data repositories, shared links, publicly available folders, or other data managed by a SaaS application 334. In the following discussion “SaaS data” refers to an intercepted API call or data detected curing a scan of data managed by a SaaS application 334.

The CASB API module 102c evaluates the SaaS data according to a policy and performs any remediative actions required according to the policy (see FIG. 7 and corresponding description).

Referring to FIG. 4, a secure email gateway 102a, SSE service 102b, and/or CASB API module 102c may execute the illustrated method 400. The method 400 may include intercepting data. Intercepting data may include intercepting 402a an email by a secure email gateway 102a, intercepting 402b network traffic by the SSE service 102b, and/or intercepting 402c SaaS data. The SSE service 102b may implement man in the middle (MITM), transport layer security (TLS) interception, or other interception technique known in the art in order to intercept the network traffic, e.g., network packets.

The intercepted data may be extracted from the object that was intercepted at step 402a,402b, or 402c such that the extracted data is in a required format, such as in a multimedia data format. For example, data may be extracted 404a from an email by some or all of extracting the text of the email, downloading an attachment included in the email, or retrieving data referenced by a link (e.g., uniform resource locator (URL)) included in the email.

In the case of network traffic, data may be extracted 404b from intercepted packets and assembled to obtain a multimedia file included in the packets. In the case of SaaS data, data referenced by an API call, shared link, SaaS database may be downloaded 404c.

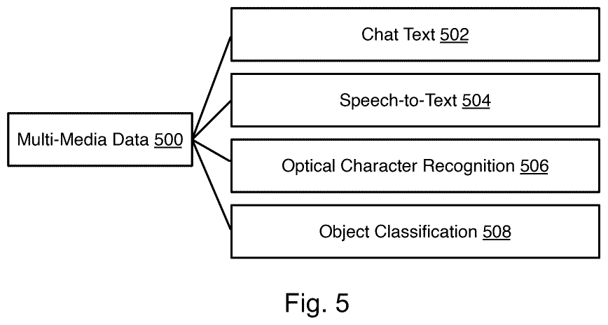

The result of any of steps 404a, 404b, 404c may be a multimedia file that may then be processed according to subsequent steps of the method 400. For example, the method 400 may include splitting 406 the multimedia data into two or more sub-media channels and converting 408 non-text data of one or more of the sub-media channels into text. For example, referring to FIG. 5, multimedia data 500 of a video conference may include chat text 502 that is extracted from the multimedia data 500 at step 406. For example, the multimedia data 500 may be data transmitted in the context of a video conference and the chat text may be text shared by participants during the video conference.

Audio data from the multimedia data 500 may be processed using a speech-to-text algorithm 504 to obtain a text transcript. Image frames in the multimedia data may be processed to identify text represented in the image frames (screen sharing, documents visible in camera fields of view, etc.), such as using an optical character recognition algorithm 506.

Video data (either collectively or as individual frames) may be processed by an object classification algorithm 508 for object recognition and to obtain contextual information. For example, objects may be identified and classified using a machine learning model trained to perform this task, such as a residual neural network (ResNet) or other type of artificial intelligence model. For example, the object classification algorithm 508 may identify a circuit board, rendering of a model of a part, circuit diagram, architectural drawing, or other type of visual representation of a three-dimensional object, schematic representation of a device or system, or the like, thus obtaining contextual information. The output of the object classification algorithm 508 may be a textual description of information represented in images of the multimedia data 500.

Note that any of the algorithms 504, 506, 508 may be performed in a contextual manner to obtain contextual information. For example, chat text 502 and/or a transcript obtained from step 404a, 404b, 404c may be used as context for execution of the optical character recognition algorithm 506 and/or object classification algorithm 508 for object recognition to obtain contextual information. Contextual information for an image may indicate what is represented in the image. For example, contextual information may indicate how the image was captured, such as a screen shot, the software that produced the image, the file of which the image is a rendering, a video file including the image, or other information. Contextual information may include dialog or chat text received at the time of sharing the image that may indicate what is represented in the image.

Referring again to FIG. 4, the method 400 may include collecting 410 context. The context may include data describing the circumstances in which the multimedia data 500 was obtained. For an email, the context may include a sender email address (or user identifier of a sender), recipient email address (or user identifier of the recipient), role-based access control (RBAC) data for the sender and the recipient, and/or other information. For network packets, a context may include source address and destination of the packets, a network protocol used, source and destination ports, user identifiers of the sender and recipient of the packets, RBAC data for the sender and the recipient, and/or other information. For data downloaded from a SaaS application, the context may include the user identifier that owns a process that made an API call (e.g., the sender) intercepted at 402c, user identifier of a recipient that receives result of the API call, identifier of the SaaS application, RBAC data for the sender and recipient, and/or other information.

The method 400 may then include evaluating 412 the text from step 408 and the context collected at step 410 according to a policy and, if indicated by the policy, performing a remediative action.

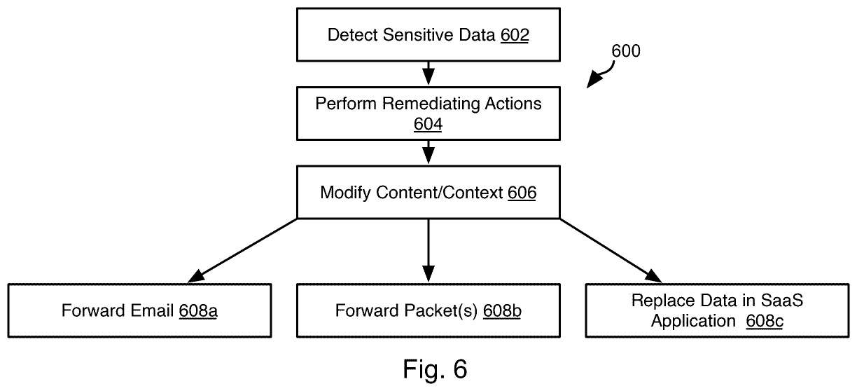

FIG. 6 illustrates an example method 600 for performing step 412. The method 600 may include detecting 602 sensitive data. The method 400 and the method 600 may be performed by different software modules that may be co-located or remote from one another. Alternatively, the same software module may perform both the method 400 and the method 600.

For example, referring to FIG. 7, inputs to step 602 may include the text 700 obtained at step 408, participant identifiers 702 (e.g., identifiers of sender and/or recipient), role-based access control (RBAC) data 704, and one or more sensitive data definitions 706.

Participant identifiers 702 may include the user identifier with respect to which a sender is authenticated, the user identifier with respect to which a recipient is authenticated; identifiers of participant in a video conference call represented by the multimedia data 500; email addresses of one or more recipients of an email; one or more accounts of a SaaS application that are the recipients of the multimedia data 500 or otherwise are granted access to the multimedia data 500 by the SaaS application, or other user identifier.

RBAC data 704 may include data defining the access privileges associated with a participant identifier 702. The RBAC data 704 may specify access privileges of an organization, business unit, or other group that a participant identifier 702 is associated with. RBAC data 704 may define privileges of a participant identifier 702 to view, edit, and/or share an item of data, type of data, or other sub-division of sensitive data. RBAC data 704 may be maintained and processed in the context of a zero trust network access (ZTNA) policy and algorithm that requires all users to authenticate before providing access to data. The participant identifiers 702 may be available due to authentication procedures implemented according to the ZTNA policy and algorithm.

The one or more sensitive data definitions 706 may define one or more specific items of data, one or more types of data, one or more other sub-divisions of data for which access is controlled according to the method 400. Examples of specific items of data may include serial numbers, part numbers, document names, directory locations, uniform resource locators (URL), or other identifiers of parts or products that have not been publicly released. Other items of data may include images, text, or other information from content that has not been publicly released.

A data definition 706 may identify data of a particular form (social security numbers of the form XXX-XX-XXXX), one or more key words or text patterns, a data format (e.g., health records), a file type, one or more object classifications (circuit board, computer aided design (CAD) model, schematic, etc.) that may be output by the object classification algorithm 508, or other descriptor.

Detecting sensitive data at step 602 may include evaluating whether the text 700 includes sensitive data as define by at least one sensitive data definition 706 and, if so, evaluating whether the participant identifiers 702 are not authorized to access the sensitive data according to the RBAC data 704.

Referring again to FIG. 6, if sensitive data is detected at step 602 the participant identifiers 702 are not authorized to access the sensitive data, the remaining steps of the method 600 may be performed, otherwise the method 600 may end. If sensitive data is not detected, emails may be forwarded to the recipient address without modification, packets may be forwarded without modification, and data managed by a SaaS application may remain unmodified.

If sensitive data is detected at step 602, the method 600 may include performing 604 a remediative action and modifying 606 one or both of the content and context of data intercepted at step 402a, 402b, or 402c.

For example, the remediative action of step 604 may include blocking the media data from reaching the participant or removing a portion of the media data containing sensitive data identified according to the sensitive data definition. For example, portions of image frames representing objects or text identified as sensitive data may be blurred or redacted (e.g., set to black), and audio data corresponding to text identified as sensitive may be overwritten or otherwise obscured. Text sent in a chat may be blocked or redacted to exclude data identified as sensitive.

The remediative action of step 604 may be implemented by the endpoint remediation engine 212, the network remediation engine 214, or an endpoint agent 270. For example, the endpoint remediation engine 212 may intercept and modify packets to remove sensitive data to obtain modified packets that are then forwarded by the SSE service 102b. The network remediation engine 214 may intercept and modify packets to remove sensitive data to obtain modified packets that are then forwarded by the SSE service 102b to a destination address of the packets. The endpoint agent 270 may be instructed to resend a modified version of a packet that does not include the sensitive data.

The remediative action of step 604 may be implemented by the CASB API module 102c, such as by removing sensitive data from a publicly accessible folder or making a link to sensitive data private.

The method 600 may include forwarding data modified at step 606. For example, where an email was intercepted at step 402a, the method 600 may include forwarding 608a the email as modified to the recipient email address of the email. For example, a multimedia file included in an email may be modified to remove sensitive data. The email may then be forwarded to the recipient with the modified multimedia file as an attachment. Alternatively, the email may be sent without the multimedia file. In yet another alternative, a multimedia file referenced by a link in an email may be modified or the link may be replaced with a link Where data packets are intercepted at step 402b, the multimedia data as modified at step 606 may be encapsulated into a plurality of new packets that are forwarded 608b to the destination address of the intercepted packets.

Where an API call to a SaaS application is intercepted at step 402c, multimedia data referenced by the API call may be replaced 608c with multimedia data as modified at step 606. The modified multimedia data may be returned at step 608c as a result of the API call or stored at step 608c in a database in place of the multimedia data referenced by the API call. Alternatively, step 606 may include modifying a result of the API call to omit a public link or replace a public link with a private link that requires authentication to access and the private link may be returned at step 608c to a recipient of a result of the API call at step 608c.

As is readily apparent, the methods 400, 600 provide an approach for performing data loss prevention (DLP) with respect to live data and with respect to static data at the time of distribution. The processing of the methods 400 and 600 may be performed in real time following receipt of data at step 402, such as within 60 seconds, 10 seconds, or 1 second following receipt of data at step 402. Performing the methods 400 and 600 therefore creates only a small lag that may be imperceptible to attendees of an audio or video conference, listeners of a podcast, or other consumer of multimedia content.

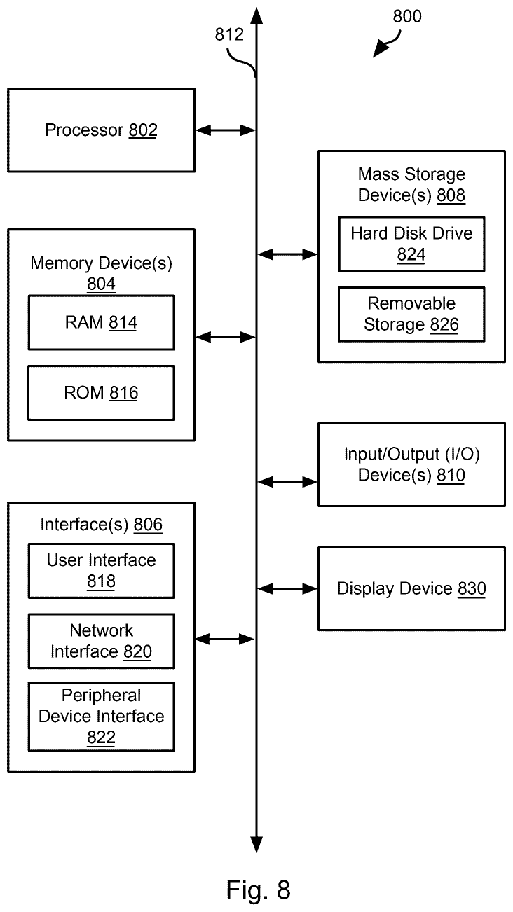

FIG. 8 is a block diagram illustrating an example computing device 800 which can be used to implement the system and methods disclosed herein. In some embodiments, a cluster of computing devices 800 interconnected by a network may be used to implement any one or more components of the invention.

Computing device 800 may be used to perform various procedures, such as those discussed herein. Computing device 800 can function as a server, a client, or any other computing entity. Computing device can perform various monitoring functions as discussed herein, and can execute one or more application programs, such as the application programs described herein. Computing device 800 can be any of a wide variety of computing devices, such as a desktop computer, a notebook computer, a server computer, a handheld computer, tablet computer and the like.

Computing device 800 includes one or more processor(s) 802, one or more memory device(s) 804, one or more interface(s) 806, one or more mass storage device(s) 808, one or more Input/Output (I/O) device(s) 810, and a display device 830 all of which are coupled to a bus 812. Processor(s) 802 include one or more processors or controllers that execute instructions stored in memory device(s) 804 and/or mass storage device(s) 808. Processor(s) 802 may also include various types of computer-readable media, such as cache memory.

Memory device(s) 804 include various computer-readable media, such as volatile memory (e.g., random access memory (RAM) 814) and/or nonvolatile memory (e.g., read-only memory (ROM) 816). Memory device(s) 804 may also include rewritable ROM, such as Flash memory.

Mass storage device(s) 808 include various computer readable media, such as magnetic tapes, magnetic disks, optical disks, solid-state memory (e.g., Flash memory), and so forth. As shown in FIG. 8, a particular mass storage device is a hard disk drive 824. Various drives may also be included in mass storage device(s) 808 to enable reading from and/or writing to the various computer readable media. Mass storage device(s) 808 include removable media 826 and/or non-removable media.

I/O device(s) 810 include various devices that allow data and/or other information to be input to or retrieved from computing device 800. Example I/O device(s) 810 include cursor control devices, keyboards, keypads, microphones, monitors or other display devices, speakers, printers, network interface cards, modems, lenses, CCDs or other image capture devices, and the like.

Display device 830 includes any type of device capable of displaying information to one or more users of computing device 800. Examples of display device 830 include a monitor, display terminal, video projection device, and the like.

Interface(s) 806 include various interfaces that allow computing device 800 to interact with other systems, devices, or computing environments. Example interface(s) 806 include any number of different network interfaces 820, such as interfaces to local area networks (LANs), wide area networks (WANs), wireless networks, and the Internet. Other interface(s) include user interface 818 and peripheral device interface 822. The interface(s) 806 may also include one or more user interface elements 818. The interface(s) 806 may also include one or more peripheral interfaces such as interfaces for printers, pointing devices (mice, track pad, etc.), keyboards, and the like.

Bus 812 allows processor(s) 802, memory device(s) 804, interface(s) 806, mass storage device(s) 808, and I/O device(s) 810 to communicate with one another, as well as other devices or components coupled to bus 812. Bus 812 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 800, and are executed by processor(s) 802. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

1. A method comprising:
receiving, by a computer system functioning as a cloud service, multimedia data; and
performing, by the computer system, within 60 seconds of receiving the multimedia data:
extracting the multimedia data into a required format;
splitting, by the computer system, the multimedia data into a plurality of sub-media channels;
processing, by the computer system, the plurality of sub-media channels to extract at least one of text, objects, or contextual information from the plurality of sub-media channels;
determining, by the computer system, that at least one of the text, the objects, or contextual information includes sensitive data; and
in response to determining that the at least one of the text, the objects, or the contextual information the text includes the sensitive data, performing, by the computer system, a remediating action.

2. The method of claim 1, wherein the cloud service is one of a network proxy or a secure email gateway.

3. The method of claim 1, wherein the cloud service is a cloud access security broker evaluating application programming interface (API) calls of a software as a service (SaaS) application.

4. The method of claim 1, wherein the plurality of sub-media channels include a plurality of channels of a video conferencing platform.

5. The method of claim 4, wherein the plurality of channels include two or more of chat text, an audio channel, an image channel, a file stream, or a collaboration channel.

6. The method of claim 1, wherein processing the plurality of sub-media channels to extract the text from the plurality of sub-media channels comprises performing optical character recognition (OCR).

7. The method of claim 1, wherein processing the plurality of sub-media channels to extract the text from the plurality of sub-media channels comprises executing a speech-to-text algorithm.

8. The method of claim 1, wherein processing the plurality of sub-media channels to extract the text from the plurality of sub-media channels comprises performing object recognition.

9. The method of claim 1, wherein intercepting the multimedia data includes intercepting packets including the multimedia data.

10. The method of claim 9, wherein the packets are transmitted during a live audio or video conference.

11. The method of claim 1, wherein the contextual information describes what is represented in the objects.

12. The method of claim 1, wherein the multimedia data is referenced by a call to a software as a service (SaaS) application.

13. The method of claim 1, wherein intercepting the multimedia data includes intercepting data transmitted by a software as a service (SaaS) platform.

14. The method of claim 1, wherein intercepting the multimedia data includes intercepting an email including the multimedia data.

15. The method of claim 1, wherein intercepting the multimedia data includes intercepting the multimedia data using a secure service edge (SSE).

16. The method of claim 15, wherein the SSE operates as at least one of a proxy and a gateway.

17. The method of claim 15, wherein the SSE executes in a cloud computing environment, the computer system being part of the cloud computing environment.

18. The method of claim 1, further comprising:
evaluating, by the computer system, an access privilege of a recipient for the multimedia data;
determining, by the computer system, that the access privilege does not allow access to the multimedia data; and
performing, by the computer system, the remediating action in response to both of determining that the at least one of the text, the objects, or contextual information includes sensitive data and determining that the access privilege does not allow access to the sensitive data.

19. A non-transitory computer readable medium storing executable code that, when executed by one or more processing devices, causes the one or more processing devices to:
receive multimedia data; and
perform within 60 seconds of receiving the multimedia data:
extracting the multimedia data into a required format;
splitting the multimedia data into a plurality of sub-media channels;
processing the plurality of sub-media channels to extract at least one of text, objects, or contextual information from the plurality of sub-media channels;
determining that the at least one of the text, the objects or the contextual information includes sensitive data; and
in response to determining that the at least one of the text, the objects, or the contextual information includes the sensitive data, performing a remediating action.

20. The non-transitory computer readable medium of claim 19, wherein the multimedia data is a video conference call.
